(19) United States
(12) Patent Application Publication
(10) Pub. No.: US 2003/0088632 A1
(43) Pub. Date: May 8, 2003

(54) Notification method, program, and system

(75) Inventors: Hiroyuki Fukunaga, Kawasaki (JP); Toshimitsu Kuroda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/108,330

(22) Filed: Mar. 29, 2002

(30) Foreign Application Priority Data
Nov. 2, 2001 (JP) 2001-337849

(51) Int. Cl. G06F 15/16

(52) U.S. Cl. 709/206; 702/177

(57) ABSTRACT

Conventional methods of retrieving a transport schedule aim merely at retrieval. Users tend to forget utilizing any such method. According to the present invention, a transport schedule registered at a user terminal is referenced. When it is judged that a notification concerning the schedule should be transmitted, the notification is transmitted to a contact address registered at the user terminal. The registered transport schedule presents a moving time required for a user to reach a point of departure of an initially utilized transport. The notification concerning the schedule is transmitted based on a user departure time instant that is earlier than the departure time instant of the initially utilized transport by the moving time.

### BACKGROUND OF THE INVENTION

1. Field of the Invention

The present invention relates to a transport schedule notification method, program, and system for notifying a user of a transport schedule, which the user has registered, at any time instant.

2. Description of the Related Art

Currently, some web sites on the Internet provide the service of retrieving a guide to changing trains. The contents of the service are such that: a user enters the conditions for retrieval, such as, the first point of departure where a user rides on a transport, a final point of arrival, and a departure time instant (date) at the first point of departure or an arrival time instant (date) at the final point of arrival; and a server in turn retrieves transit routes, and departure time instants at certain points or arrival time instants thereat which meet the conditions, and presents on a web site some of the results of the retrieval as candidates in order of a required time, a fare, or the number of points through which a transit is made.

Currently, users merely refer to the results of retrieval. The user must therefore memorize a departure time instant. However, the user tends to forget the departure time instant.

According to the currently available contents of the service, the departure time instant of an initial transport is presented. Actually, a user must take account of the time required to go to the point of departure of the transport. Supposing the user remembers the departure time instant, the time instant at which the user must leave so as to reach the point of departure in time may elapse. Eventually, the user may miss his/her scheduled transport.

In other words, although an information providing means for providing a user with a guide to changing of trains is available, a means for prompting the user to leave so as to catch his/her intended train is not available.

If a user misses an initially planned train, the user must retrieve a transport schedule again. Moreover, the user must enter the conditions for retrieval again.

Specifically, a problem underlies the circumstance that the conditions for retrieval entered initially (or a result of retrieval, that is, a transport schedule) cannot be reused. Moreover, if a user misses an initially scheduled transport, an alternative transport schedule should be provided automatically.

### SUMMARY OF THE INVENTION

Accordingly, an object of the present invention is to solve the foregoing problems and to notify a user to leave so as to catch his/her scheduled transport.

Another object of the present invention is to make it possible to readily reuse the initially-entered conditions for retrieval or a transport schedule that is a result of retrieval, and to provide a new transport schedule if a user misses his/her initially scheduled transport.

According to the present invention, there are provided a notification method, program, and system for referencing a transport schedule registered at a user's terminal, judging whether a notification concerning the schedule should be transmitted, and transmitting the notification to a contact address registered at the user's terminal if it is judged that the notification should be transmitted.

According to the present invention, preferably, the transport schedule presents a moving time required for a user to reach a point of departure of a transport to be utilized initially. The notification concerning the transport schedule is transmitted to the user according to a user departure time instant that is earlier than the departure time instant of the initially utilized transport by at least the moving time.

According to the present invention, preferably, the transport schedule presents a time instant at which a notification concerning the transport schedule is automatically transmitted. Based on the transmission time instant, the notification concerning the transport schedule is transmitted.

According to the present invention, preferably, the transport schedule presents a time instant at which the notification concerning the transport schedule is automatically retransmitted or a time interval between the time instants at which the notification is automatically retransmitted. Based on the retransmission time instant or the retransmission time interval, the notification concerning the transport schedule is transmitted.

According to the present invention, preferably, if it is judged that the transmission time instant or retransmission time instant passes the user departure time instant, the user departure time instant is updated to the transmission time instant or retransmission time instant. Based on the updated user departure time instant, the transport schedule is retrieved from a timetable database in which the timetables of transports are recorded. The transport schedule that is a result of retrieval is then transmitted.

According to the present invention, preferably, the transport schedule presents a member identification (hereinafter ID) code that is registered in advance, and an arrival time instant at a final point of arrival. On receipt of the member ID code, the transport schedule is transmitted to the user terminal, from which the member ID code has been transmitted, until the arrival time instant. Consequently, as long as the user has not reached the final point of arrival, if the user transmits his/her member ID code at his/her user terminal, the user can check the registered transport schedule without the necessity of re-entering the conditions for retrieval. Otherwise, if it is judged that the user will miss his/her scheduled transport, the user can check for a new updated transport schedule.

According to the present invention, preferably, the transport schedule presents information that specifies a transmission medium over which a notification concerning the transport schedule is transmitted to the contact address. The notification is then transmitted over the specified transmission medium.

### BRIEF DESCRIPTION OF THE DRAWINGS

FIG. 1 shows a system configuration in accordance with the present invention;

FIG. 2 is a flowchart describing an overall processing sequence involving a user terminal 130 and a notification system 100 in accordance with the present invention;

FIGS. 3A to 3B are flowcharts describing a processing sequence for notification designation in accordance with the present invention;

FIGS. 4A to 4B are flowcharts describing a processing sequence for notification in accordance with the present invention;

FIG. 5 is a flowchart describing a processing sequence for retrieval in accordance with the present invention;

FIG. 6 shows a screen image presenting a result of retrieval;

FIG. 7 shows a screen image for designating automatic calling;

FIGS. 8A to 8B show screen images presenting notification messages;

FIG. 9 shows a screen image for entering the conditions for retrieval;

FIG. 10 shows a member table;

FIG. 11 shows an acknowledgement table;

FIG. 12 shows a conditions-for-notification table; and

FIG. 13 shows an example of changing data of the conditions-for-notification table.

### DESCRIPTION OF THE PREFERRED EMBODIMENTS

Referring to the drawings, an embodiment of the present invention will be described below.

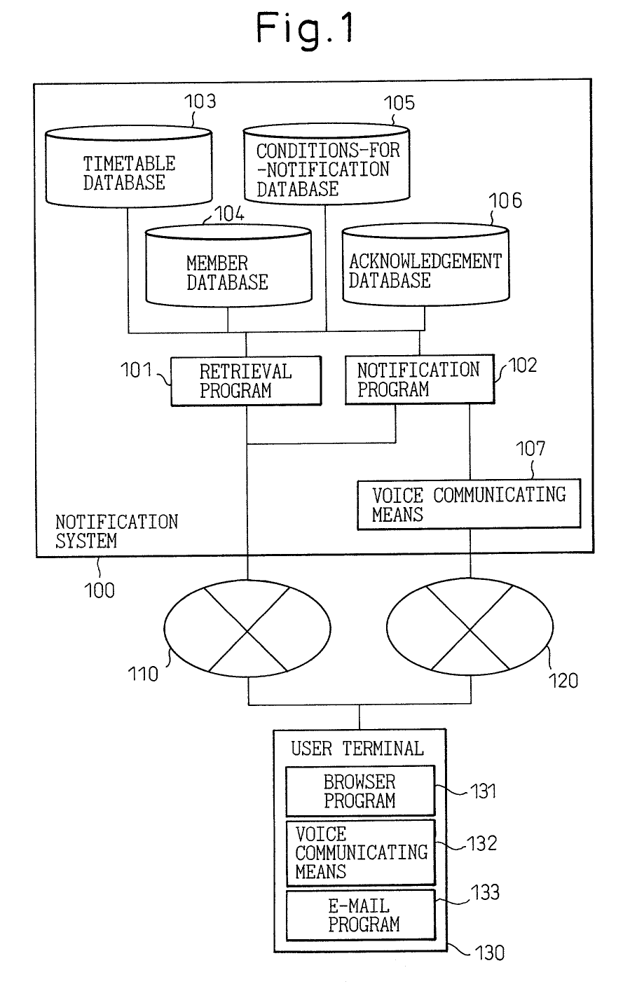

FIG. 1 shows a system configuration in accordance with the present invention. A system in accordance with the present invention consists mainly of a notification system 100, a user terminal 130, the Internet 110, and a telephone network 120.

The notification system 100 consists mainly of a retrieval program 101, a timetable database 103, a member database 104, a notification program 102, a conditions-for-notification database 105, an acknowledgement database 106, and a voice communicating means 107. The retrieval program 101 retrieves a transport schedule such as a guide to changing of trains in response to the conditions for retrieval or a member ID code sent from the user terminal 130 over the Internet 110, and transmits a result of retrieval to the user terminal. The retrieval program 101 references the timetable database 103 to retrieve the transport schedule. The member database 104 is used to manage member information including member ID codes. In response to a request for the notification to leave based on the transport schedule that is the result of retrieval, the notification program 102 records the transport schedule and the conditions for retrieval sent from the user terminal 130 in the conditions-for-notification database 105. When the conditions for notification are met, the notification program 102 transmits the notification to the user terminal 130 by electronic mail (hereinafter e-mail) or instructs the voice communicating means 107 to originate a call. The transport schedule received by the notification program 102 and the conditions for notification are recorded in the conditions-for-motification database 105. The acknowledgement database 106 is used to manage a history that records when the notification program 102 has received an acknowledgement from the user terminal 130. When the notification program 102 transmits the notification using speech, the voice communicating means 107 autonomously converts required notification data into speech, and communicates with the user terminal 130 over the telephone network 120.

The Internet 110 is a kind of data communication network. The user terminal 130 locates a home page contained in a web site on the World Wide Web provided by the notification system 100, whereby a transport schedule is retrieved or the user terminal 130 receives a notification sent from the notification program 102 by e-mail. Otherwise, the web site is located over the Internet 110 in order to check the transport schedule registered at the user terminal 130.

The telephone network 120 is used when the voice communicating means 107 notifies the user terminal 130 with speech. However, if voice communication is performed based on digital data, the telephone network 120 is substantially comparable to the Internet 110.

The user terminal 130 consists mainly of a browser program 131, the voice communicating means 132, and an e-mail program 133. The browser program 131 is used to locate the home page provided by the notification system 100, to retrieve a transport schedule or enter the conditions for notification, or to read a result of retrieval. The voice communicating means 132 receives a notification that is sent from the notification system 100 by telephone. The e-mail program 133 receives a notification from the notification system 100 by e-mail.

FIG. 1 shows only one user terminal 130. In practice, a user terminal 130 used to retrieve a transport schedule and designate notification may be physically different from a user terminal 130 used to receive a notification from the notification system 100. For example, the former may be performed at a desktop personal computer installed in an office, and the latter may be performed using a user's portable telephone.

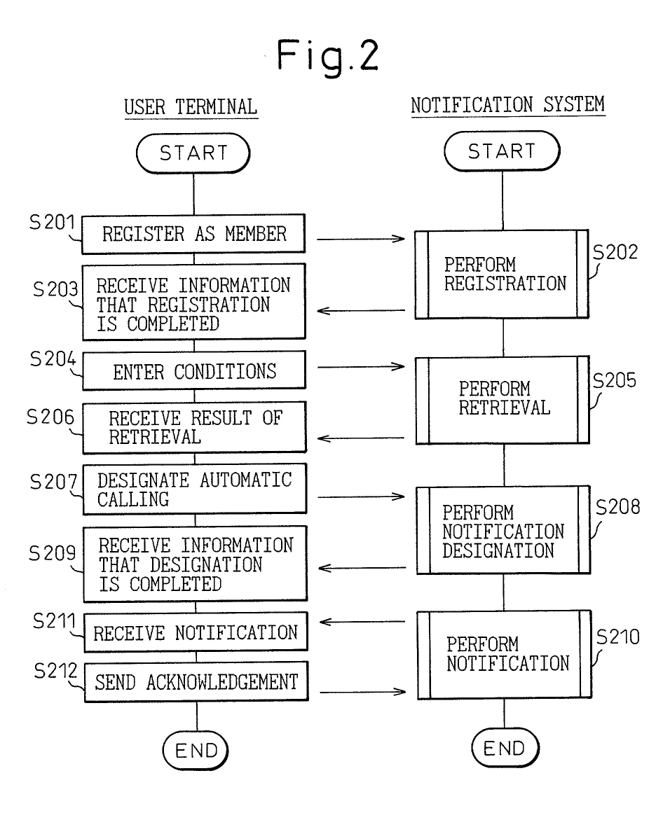

FIG. 2 is a flowchart describing an overall processing sequence involving the user terminal 130 and notification system 100.

At step S201, the user terminal 130 is used to locate a web site on the World Wide Web provided by the notification system 100, and to enter data so as to be registered as a member. An e-mail address and a telephone number must be entered as minimal registration information. A plurality of pairs of an e-mail address and a telephone number can be registered.

At step S202, a member registration program that is not shown receives the information entered at step S201, produces a new member ID code in association with the information, and records the member ID code in the member database 104. Thereafter, the member registration program presents a screen image for informing the user terminal 130 of the member ID code. At step S203, the member ID code is accepted at the user terminal 130. This member registration has been performed in the past and the member registration program is therefore not shown in FIG. 1.

A user who has already been registered as a member does not perform the foregoing processing but starts with step S204.

Steps S204 to S206 constitute a processing sequence for transport schedule retrieval.

At step S204, the user terminal 130 is used to access a retrieval screen image presented by the notification system 100, and to enter a member ID code and the conditions for retrieval. The conditions for retrieval may be identical to those required in order to receive a service provided according to a related art. Specifically, an initial point of departure of a transport to be utilized by a user, a final point of arrival, and a departure time instant at the initial point of departure or an arrival time instant at the final point of arrival are entered. However, if a transport schedule is re-read after notification is designated at step S208, the user should merely send his/her member ID code using the user terminal 130.

At step 205, if the notification system 100 receives only a member ID code from the user terminal 130, the notification system 100 retrieves a record associated with the member ID code from the conditions-for-notification database 105. The timetable database 103 is then automatically searched based on the retrieved conditions for registration/retrieval, whereby a transport schedule is retrieved. Consequently, a screen image presenting the result of retrieval is transmitted to the user terminal 130. If the member ID code is not recorded in the conditions-for-notification database, the timetable database 103 is searched based on the received conditions for retrieval in order to retrieve a transport schedule. The result of retrieval is then displayed on the user terminal 130.

The retrieval is identical to the one employed in the related art and will therefore not be described herein. Like the related art, even in the present invention, a plurality of transport schedules is presented so that a user can select an optimal schedule from among them. However, for a better understanding of an embodiment of the present invention, a transport schedule permitting a user to reach an intended point by taking the shortest period of time shall be presented as a result of retrieval. When a transport schedule is retrieved for the first time, a screen image showing buttons which a user uses to designate notification is transmitted to the user terminal 130 together with the result of retrieval.

At step S206, the user terminal 130 receives a result-of-retrieval screen image from the notification system 100 at step 205.

Steps S207 to S209 constitute a processing sequence for notification designation.

At step 207, if a user wants to be notified to leave according to the transport schedule displayed on the result-of-retrieval screen image received by the user terminal at step S206, the user designates automatic calling (notification) using the result-of-retrieval screen image. With the user's maneuver, a member ID code, a notification request, the transport schedule that is the result of retrieval, and various conditions required for notification are transmitted from the user terminal 130 to the notification system 100.

At step S208, the notification system 100 records the various data items sent from the user terminal 130 in the conditions-for-notification database 105. When the recording is completed, a screen image that expresses completion of notification designation is transmitted to the user terminal 130. At step S209, the user terminal 130 receives the screen image and the user recognizes that notification designation is completed.

Steps S210 to S212 constitute a processing sequence for notification to leave.

At step S210, the notification system 100 references the conditions that are recorded in the conditions-for-notification database 105 at step S208. If the conditions for notification are met, the notification system 100 originates an e-mail or a call to the user terminal 130 so as to notify the user to leave. If notification is designated again, the conditions for notification are updated. At step S211, the user terminal 130 receives the notification from the notification system 100. If the user wants to discontinue designation of notification concerning a schedule (that is, the user does not want to designate notification any longer), the user uses the user terminal 130 to transmit an acknowledgement to the notification system 100.

According to the embodiment of the present invention, as long as the notification system 100 does not receive an acknowledgement from the user terminal 130, the notification system 100 repeatedly transmits the notification to leave at preset intervals. Otherwise, an upper limit may be set for the number of times by which the notification is retransmitted. In this case, if the number of times by which the notification is retransmitted reaches the upper limit, the notification will not be retransmitted to the user terminal 130 any more.

The overall processing sequence involving the user terminal 130 and notification system 100 has been described briefly.

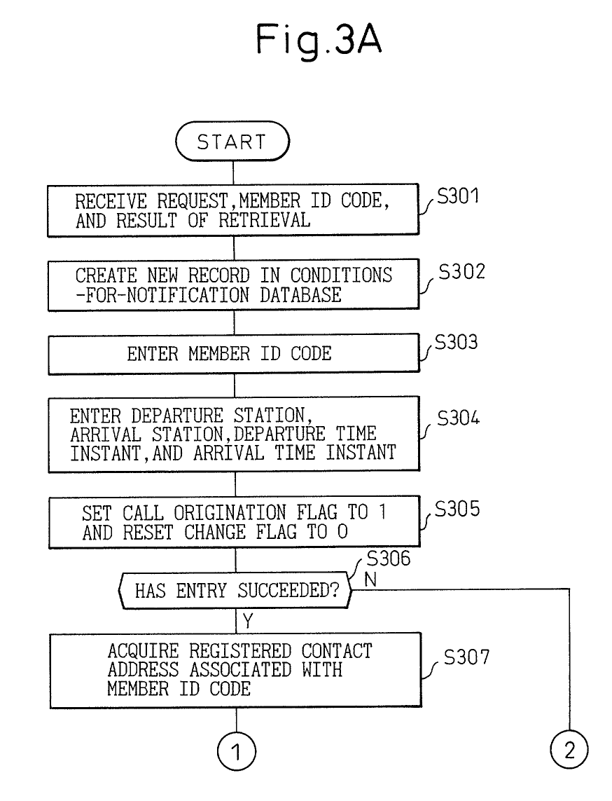

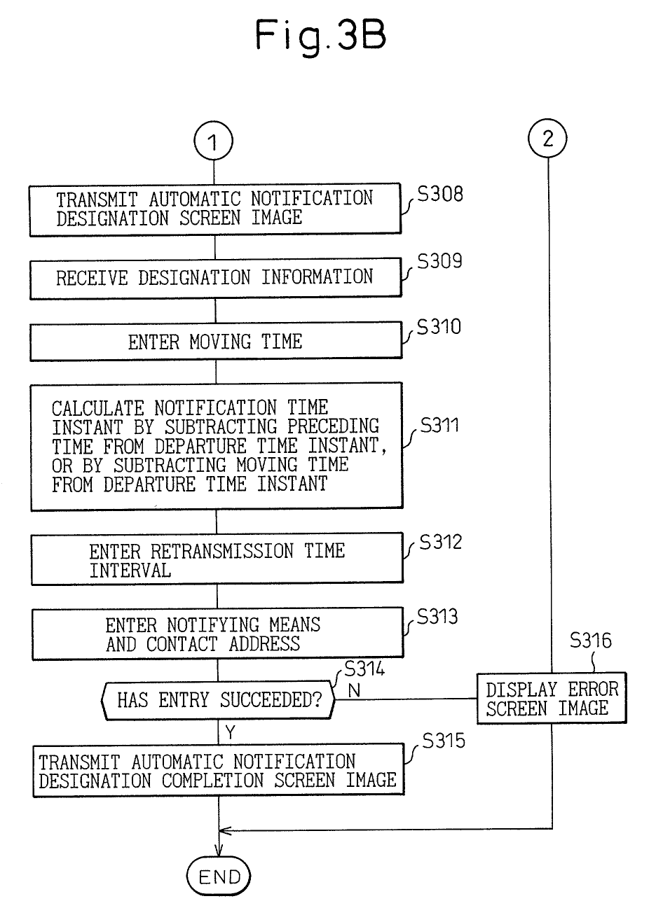

Referring to FIGS. 3A to 3B and others, notification designation, notification, and checking of a transport schedule relative to which notification is designated, which are the features of the present invention, will be described below.

FIGS. 3A to 3B are flowcharts describing a processing sequence for notification designation in accordance with the present invention.

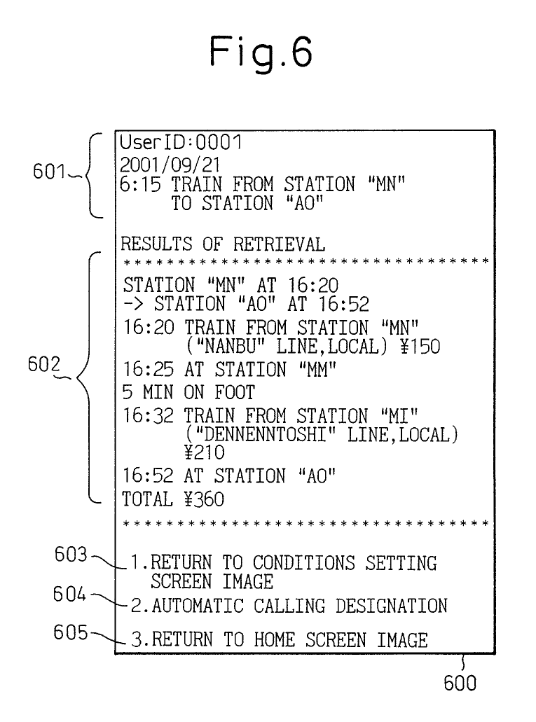

At step S301, the notification program 102 receives a request for notification designation, a member ID code, and a transport schedule that is a result of retrieval from the user terminal 130. Specifically, at step S205, the retrieval program 101 transmits a result-of-retrieval screen image 600 like the one shown in FIG. 6 to the user terminal 130. When an automatic calling designation button 604 shown in the result-of-retrieval screen image 600 is pressed, the various information items are transmitted to the notification program 102.

The result-of-retrieval screen image 600 consists of user-designated conditions 601, a transport schedule 602 that is a result of retrieval, a return-to-conditions setting screen image button 603, the automatic calling designation button 604, and a return-to-home screen image button 605.

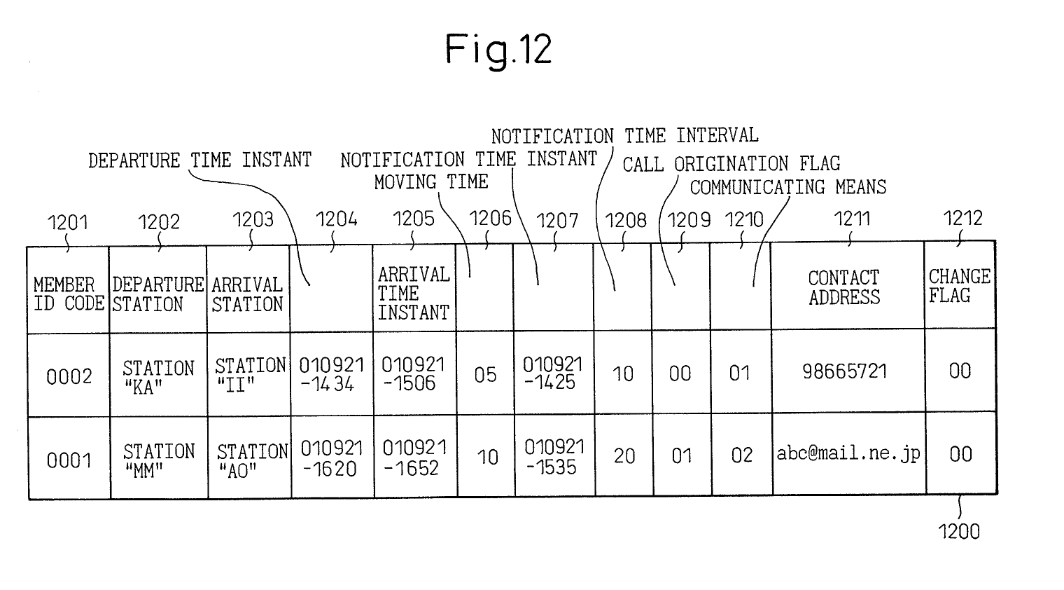

At step S302, the notification program 102 creates a new record in a conditions-for-notification table 1200 in the conditions-for-notification database 104. The conditions-for-notification table 1200 has a data structure shown in FIG. 12.

At step S303, the notification program 102 enters a member ID code in a column 1201. At step S304, a departure station, an arrival station, a departure time instant, and an arrival time instant are entered in respective columns 1202, 1203, 1204, and 1205. For example, assume that designation of automatic calling is requested using the result-of-retrieval screen image 600 shown in FIG. 6. In this case, the data items are specified in columns 1201 to 1204 in the second record of the conditions-for notification table 1200 as shown in FIG. 12.

At step S305, the notification program 102 sets a call origination flag in column 1209 to 01 (meaning that notification is requested). Moreover, a change flag in column 1212 is reset to 00 (meaning that schedules are not changed). Based on the call origination flag in column 1209, the notification program 102 judges whether a notification to leave should be transmitted to the user terminal 130 according to the record. As the call origination flag, either of the values 01 (meaning that notification is requested) and 00 (meaning that notification is not requested) is specified in column 1209.

The change flag in column 1212 indicates whether a schedule recorded at step S304 has been changed to another. According to the present embodiment, when a user is notified to leave, if the notification program 102 judges that the user will not be able to catch an initially scheduled transport, another available transport schedule is automatically retrieved and transmitted to the user. At this time, a notification format different from a normal format is adopted in order to explicitly indicate that schedules have been changed. The change flag in the column 1212 is used as an identifier based on which the notification program 102 judges whether the change notification format should be adopted. If another schedule is retrieved, the change flag that has been reset to 00 is set to 01 (meaning that schedules are changed).

At step S306, the notification program 102 judges whether data entry performed at steps S303 to S305 has succeeded. If data entry has succeeded, the notification program 102 proceeds to a sequence starting at step S307. If the data entry has failed, the notification program 102 proceeds to step S316. A screen image for informing the user of the fact that notification designation has failed is displayed on the user terminal 130. The notification designation sequence is then terminated.

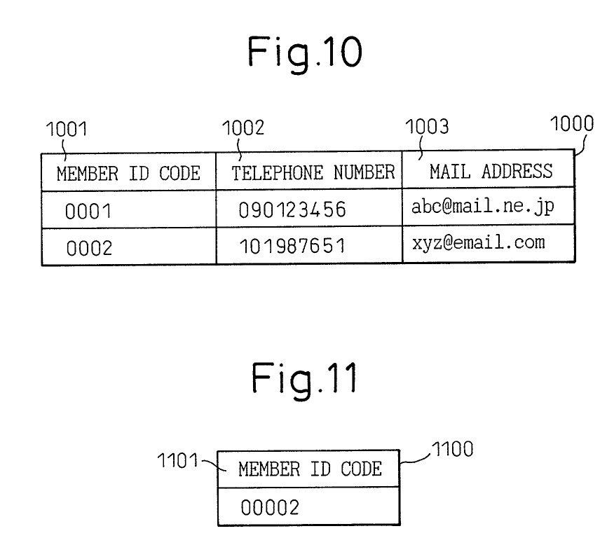

At step S307, the notification program 102 references the member database 104, and reads a contact address associated with the member ID code. A member table 1000 in the member database 104 has a data-structure like the one shown in FIG. 10. Taking the result-of-retrieval screen image shown in FIG. 6 for instance, the notification program 102 retrieves “0001” from member ID code column 1001 in the member table 1000. The notification program 102 then reads a telephone number and a mail address from telephone number column 1002 and mail address column 1003 in the record of the member having the member ID code (in FIG. 10, the first record). In the example shown in FIG. 10, one data is recorded in the telephone number column and mail address column. Alternatively, a plurality of data items may be recorded.

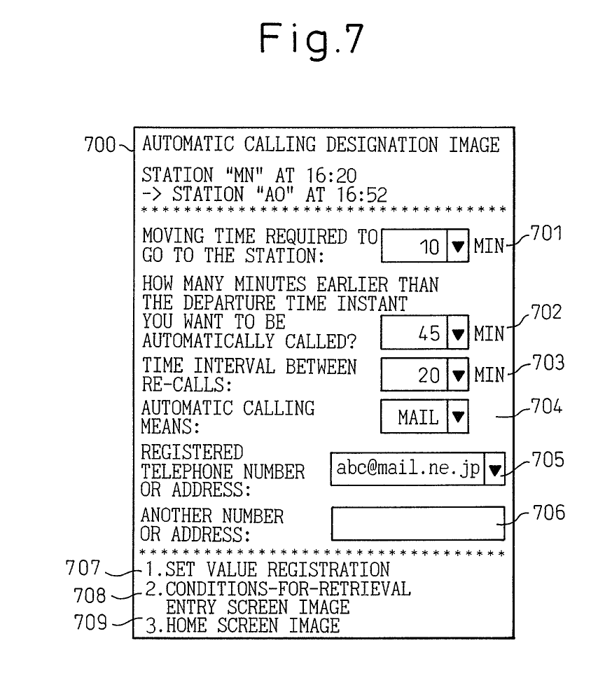

At step S308, the notification program 102 displays an automatic calling designation screen image 700 like the one shown in FIG. 7 on the user terminal 130.

The automatic calling designation screen image 700 is displayed to permit a user to set various conditions for notification. The conditions for notification include a moving time 701 required for the user to get to a departure station, a time instant 702 at which the user wants to be notified first (a time instant earlier than a departure time instant in FIG. 7), a retransmission time interval 703 between time instants at which the user is notified, a notifying means 704, a registered contact address 705, and another contact address 704 that is not the registered contact address.

In order to help a user enter each set value, predefined options are, as shown in FIG. 7, presented in the form of a pull-down menu. Alternatively, the screen image may be designed so that a user can enter his/her desired set value.

Talking of the time instant 702 (time instant earlier than the departure time instant in FIG. 7) at which a user is notified for the first time, if the user selects an option of designating no specific value, the first notification time instant is set to a time instant earlier than the departure time by the moving time 701.

When either of “telephone” and “e-mail” is selected as the notifying means 704, a registered contact address dependent on the selection is presented for the contact address 705 while being contained in a pull-down menu. In the example shown in FIG. 7, “e-mail” is selected for the notifying means 704. Therefore, a mail address abc@mail.ne.jp read from the mail address column 1003 in associated with the member ID code “0001” specified in the column 1001 in the member table 1000 is contained in the pull-down menu for the registered contact address 705.

If the user wants to receive a notification at an address other than the address specified as an option for the registered contact address 705, the registered contact address 705 is left blank. The address is entered directly for another contact address 706.

The automatic calling designation screen image 700 contains, in addition to the areas in which the foregoing conditions for notification are set, a set value registration button 707 to be used to transmit the above conditions for notification to the notification program 100, a button 708 to be used to request display of a conditions-for-retrieval entry screen image, and a button 709 to be used to request for display of a home screen image.

For example, after the conditions for notification are set as shown in FIG. 7, if the user presses the set value registration button, the conditions for notification are transmitted from the user terminal 130. Consequently, the notification program 102 receives the data of the conditions for notification at step S309.

The notification program 102 fills out the record in the conditions-for-notification table 1200 according to the received conditions for notification. Incidentally, data has already been entered in the columns 1201 to 1205 and 1209 at steps S303 to S305.

Specifically, at step S310, the notification program 102 enters the received moving time 701 in moving time column 1206 in the conditions-for-notification table 1200. At step S311, a notification time instant at which a user wants to be notified first is entered in notification time instant column 1207. At step S312, the retransmission time interval 703 is entered in notification time interval column 1208. At step S303, the notifying means 704 is entered in notifying means column 1210, and the registered address 705 (or another contact address 706 entered directly) is entered in contact address column 1211. Thus, based on the conditions for notification shown in FIG. 7, all columns of the second record in the conditions-for-notification table 1200 shown in FIG. 12 are filled out.

Step S311 will be described further. The notification program 102 judges whether a preceding time 702 is entered in the automatic calling designation screen image 700. If the preceding time is entered, a time instant earlier than the departure time instant in column 1204 by the preceding time 702 is entered in notification time instant column 1207. If the preceding time 702 is not entered, a time instant earlier than the departure time instant in column 1204 by the moving time in column 1206 is entered in the notification time instant column 1207.

At step S314, it is judged whether data entry performed at steps S310 to S313 has succeeded. If it has succeeded, control is passed to step S315. A screen image indicating that designation of notification to leave is completed is transmitted to the user terminal 130. If the data entry has failed, control is passed to step S316. A screen image indicating that notification designation cannot be achieved is transmitted. The notification designation sequence is then terminated.

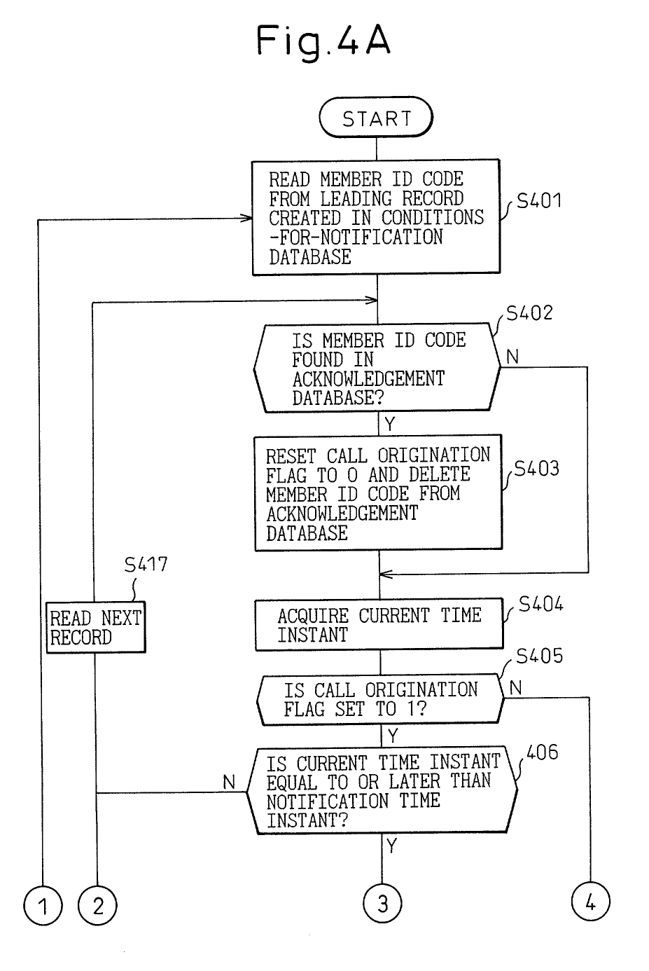

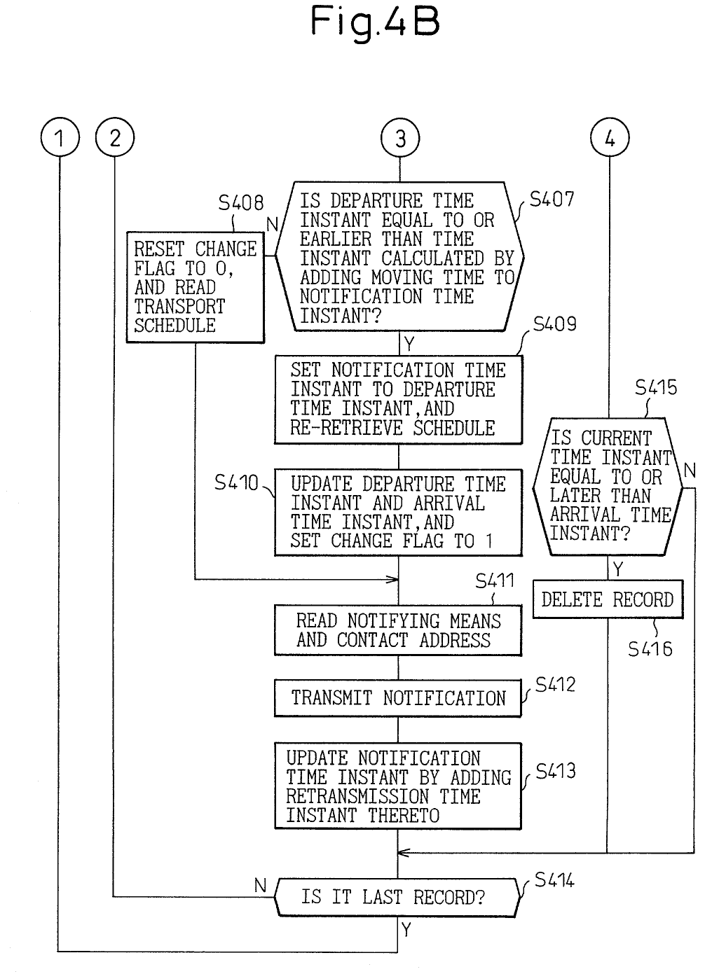

Next, a notification sequence according to which the notification program 102 transmits a notification to leave to the user terminal 130 will be described in conjunction with FIGS. 4A to 4B.

At step S401, the notification program 102 reads a member ID code from the column 1201 of the first record in the conditions-for-notification table 1200 within the conditions-for-notification database 105.

Next, at step S402, the notification program 102 references the acknowledgement table 1101 within the acknowledgement database 106 so as to judge whether the member ID code read from the column 1201 at step S401 is recorded (in the example shown in FIG. 12, “0002”). If the user terminal 130 having received the notification to leave returns an acknowledgement to the notification program 102, the member ID code of the user is recorded in acknowledgement table 1101 like the one shown in FIG. 11.

If the member ID code read from column 1201 at step S401 is recorded in acknowledgement table 1101, the notification program 102 proceeds to step S403. The value 01 (meaning that notification is requested) specified in call origination flag column 1201 of the record is changed to 00 (meaning that notification is not requested). Moreover, the member ID code is deleted from column 1101 in acknowledgement table 1100.

Moreover, if the member ID code read from column 1201 at step S401 is not recorded in the acknowledgement table 1101, the notification program 102 skips step S403 and proceeds to step S404.

At step S404, the notification program 102 learns a current time instant from a timer that is not shown.

At step S405, the notification program 102 reads the call origination flag from column 1209 of the record, and judges whether the call origination flag is set to 01 (meaning that notification is requested). If the call origination flag in column 1209 is set to 01, control is passed to step S406. If the call origination flag in column 1209 is reset to 00 (meaning that notification is not requested), control is passed to step S414. If the call origination flag in column 1209 is reset to 00, the notification program 102 judges at step S415 whether the current time instant agrees with the arrival time instant in column 1205 of the record in the conditions-for-notification table 1200 or whether the current time instant has passed the arrival time instant. If the current time instant agrees with or has passed the arrival time instant, the record is deleted. For a user having returned an acknowledgement, if the arrival time instant at the final arrival station has elapsed, the user need not reuse the transport schedule or guide to changing of trains. Therefore, unnecessary data is deleted. If the current time instant has not reached the arrival time instant specified in the column 1205, the notification program 102 performs nothing but proceeds to step S414.

If it is judged at step S405 that the call origination flag specified in the column 1209 is set to 01 (meaning that notification is requested), the notification program 102 reads at step S406 the notification time instant specified in the column 1207 of the record in the conditions-for-notification table 1200. The notification program 102 then judges whether the current time instant agrees with or has passed the notification time instant. If the current time instant agrees with or has passed the notification time instant, the notification program 102 proceeds to step S407. If the current time instant does not agree with or has not passed the notification time instant (that is, the current time instant has not yet reached the notification time instant 1207), control is passed to step S417. Judging whether the notification concerning the record should be transmitted is completed. The member ID code specified in column 1201 of the next record is then read, and control is returned to step S402.

If it is judged that the current time instant agrees with or has passed the notification time instant, the notification program 102 adds at step S407 the moving time specified in the column 1206 to the notification time instant specified in the column 1207. It is then judged whether the calculated time instant has passed the departure time instant specified in the column 1204. At the step S407, it is judged whether when the user is notified according to the notification timing, the user can catch his/her initially planned train or initially scheduled transport.

If it is judged at step S407 that when the user is notified now, the user can catch the planned train, the notification program 102 proceeds to step S408. The change flag specified in column 1212 is reset to 00. Moreover, information concerning the transport schedule or plan to change trains is read from the departure station column 1202, arrival station column 1203, departure time instant column 1204, arrival time instant column 1205, and moving time column 1206 in conditions-for-notification table 1200. The read data is developed at step S411 and thereafter.

If it is judged at step S407 that, if the user is notified now, the user will miss the planned train, the notification program 102 retrieves a new transport schedule that presents a train the user can catch when the user is notified at the notification time instant. The notification program 102 then updates the conditions-for-notification table 1200 with data drawn out of the schedule.

Specifically, at step S409, the notification program 102 reads the departure station and arrival station from columns 1202 and 1203 in conditions-for-notification table 1200. The current notification time instant specified in column 1207 is regarded as a departure time instant that is used an index for retrieval in order to retrieve a transport whose departure time is later than the departure time instant included in the conditions for retrieval. All these data items are passed as the conditions for retrieval to the retrieval program 101. The retrieval program 101 in turn acts similarly when it does to retrieve a transport schedule at step S205. The result of retrieval is sent back to the notification program 102.

At step S410, the notification program 102 updates the record in the conditions-for-notification table 1200 according to the result of retrieval sent back from the retrieval program. Namely, the notification program 102 updates the departure time instant and arrival time instant specified in the columns 1204 and 1205. The notification program then reads the updated departure time instant and arrival time instant and also reads the departure station, arrival station, and moving time from the columns 1202, 1203, and 1206 respectively. The change flag specified in the column 1212 is set to 01 (meaning that schedules are changed). At step S411, the normal notification format is unused but a new notification format is used to inform the result of retrieval. According to the new notification format, the notification program 102 produces a notification message and transmits it to the user terminal 130.

At step S411, the notification program 102 references the record in the conditions-for-notification table 1200 to retrieve the notifying means and contact address from the columns 1210 and 1211. The notification program 102 then judges whether the notification to leave should be transmitted by e-mail or should be transmitted via the voice communicating means 107 by telephone. Moreover, the notification program 102 recognizes where it should transmit the notification.

At step S412, the notification program 102 checks the change flag specified in column 1212. If the change flag is reset to 00, the normal notification format 800 is employed. If the change flag is set to 01, the schedule change notification format 850 is read out. The data items specified in the departure station column 1202, arrival station column 1203, and moving time column 1206 are entered in the schedule change notification format 850, whereby a notification message is produced. If the user terminal 130 is notified by e-mail, the notification program 102 transmits the produced notification message over the Internet 110 by e-mail. If the user terminal 130 is notified by telephone, the notification program 102 transfers the produced notification message to the voice communicating means 107. The voice communicating means 107 converts the notification message into speech, and contacts the user terminal 130 by telephone over the telephone network 120. Existing technologies are used for e-mail communication and data-to-speech conversion, and the description will therefore be omitted.

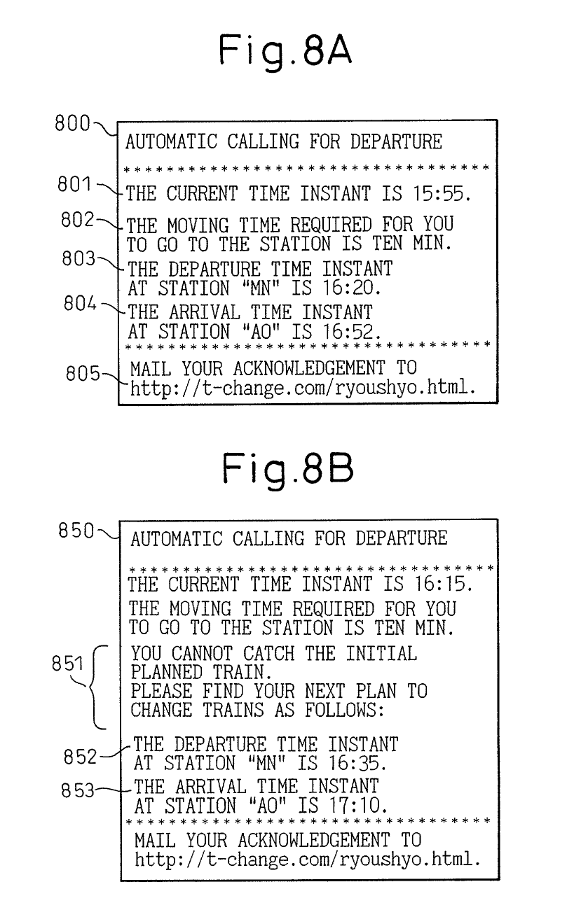

FIGS. 8A to 8B show examples of a notification message screen image for notification by e-mail. The normal notification screen image 800 contains such information as a current time instant 801, a moving time 802 required for a user to go to the station, a departure station and departure time instant 803, an arrival station and arrival time instant 804, and a uniform resource locator (URL) to which an acknowledgement should be sent. Moreover, the notification screen image 850 employed when a transport schedule or a plan to change trains is updated is almost the same as the normal screen image 800. The notification screen image 850 is different from the normal screen image 800 in the points that a message 851 signifying that transport schedules are changed is added and that the departure time instant 852 and arrival time instant 853 are updated.

The URL 805 to which an acknowledgement should be sent is located at the user terminal 130. After the user enters his/her member ID code in an acknowledgement screen image, not shown, when the user presses an acknowledgement button so as to acknowledge that he/she will be notified to leave, the notification program 102 registers the member ID code in the acknowledgement table 1100.

At step S413, the notification time instant and notification time interval specified in the columns 1207 and 1208 of the record in the conditions-for-notification table 1200 are added up. The notification time instant specified in the column 1207 is then updated with the calculated time instant. Thus, the notification sequence for the record concerned is completed. At step S414, the notification program then judges whether the next record has not been manipulated. If so, the next record is read at step S417 and the sequence starting at step S402 is performed. If there is no next record, control is returned to step S401. Notification is performed relative to the first record.

The processing sequence for notification comparable to step S210 in accordance with the present invention has been described so far. In a case where the examples of tables shown in FIG. 11 and FIG. 12 are applied, the record is concerned with the user having the member ID code “0002.” In response to an acknowledgement sent from the user terminal 130, the call origination flag specified in the column 1209 is changed from 01 (meaning that notification is requested) to 00 (meaning that notification is not requested). Moreover, the record has not been deleted but remains in the conditions-for-notification table 1200. This is because the current time instant has not yet reached the arrival time instant specified in the column 1205, that is, “15:06 on Sep. 21, 2001.” In addition, the record of the user having the member ID “0002”, will be deleted when the arrival time instant has come.

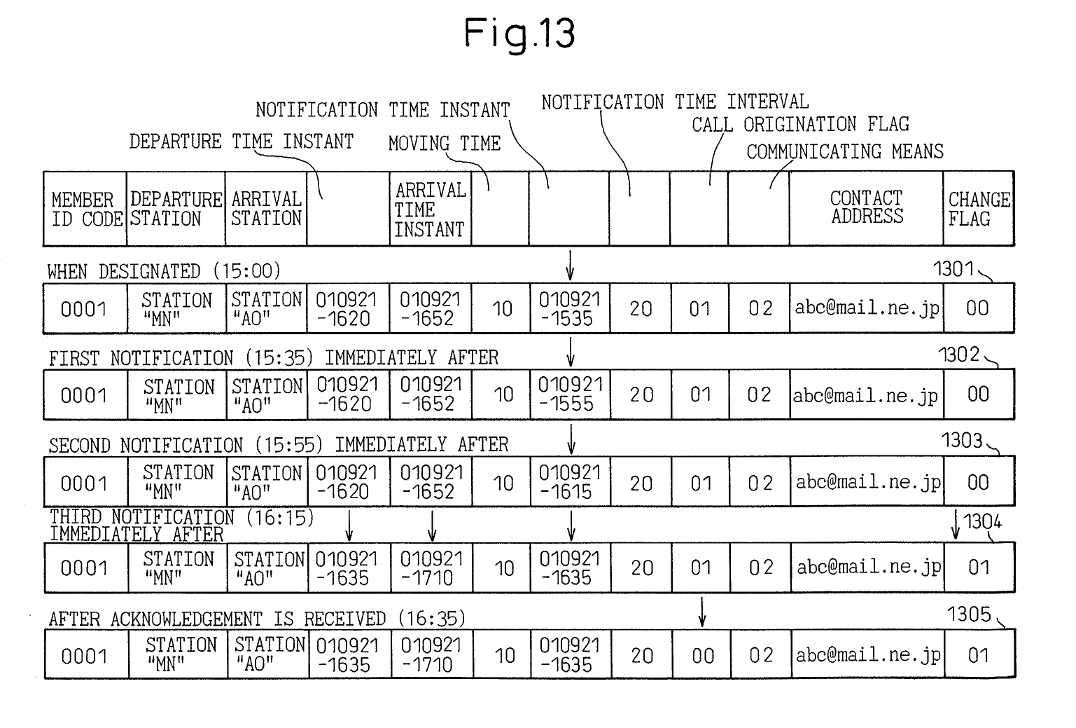

FIG. 13 shows an example of a data transition, thus showing how to update data during a period from the instant notification is designated initially to the instant the record associated with the member ID code “0001” is deleted from the conditions-for-notification table 1200 shown in FIG. 12. The transition chart is concerned with a case where a user misses an initially planned train and, when the transport schedule or plan to change trains is updated, the notification system 100 receives an acknowledgement from the user terminal 130.

Assume that the time instant when notification is designated initially is 15:00 and that the notification program 102 creates a record 1301. According to the record 1301, the first notification time instant is 15:35.

Assuming that the current time instant is the same as the first notification time instant of 15:35, the notification program 102 checks the acknowledgement table 1100. Since the member ID code “0001” is not found, the call origination flag remains 01 (meaning that notification is requested). Moreover, even when a moving time of ten min. is added to the notification time instant of 15:35, the resultant time instant does not reach the departure time instant “16:20” of a planned train. Therefore, the transport schedule or plan to change trains is not updated. According to the contents of the initial transport schedule, the notification program 102 transmits the notification to leave to the user terminal 130. The notification time interval of twenty min. is added to the current time instant of 15:35, and 15:55 is then specified as the second notification time instant. Immediately after the first notification is completed, the record associated with the member ID code “0001” becomes record 1302. The column whose data has been changed is the notification time instant column alone.

When the current time instant reaches the second notification time instant of 15:55, the notification sequence is carried out. As the notification will prove useful because the user will be able to catch the initially scheduled transport or initially planned train, the notification time alone is changed to the third time instant of 16:15. A record 1303 is then created. During this notification, a notification screen image like a screen image 800 shown in FIG. 8 is presented.

Now, the third notification time instant is 16:15. However, when the moving time of ten min. is added to the notification time instant, the resultant time instant passes the departure time instant of 16:20. Therefore, the notification program 102 retrieves the next transport schedule or next plan to change trains. Based on the result of retrieval, the departure time instant and arrival time instant are updated to 16:35 and 17:10 respectively and transmitted to the user terminal 130. At this time, as the new transport schedule is retrieved, the change flag is set to 01. Consequently, a notification screen image like the one 850 shown in FIG. 8 is transmitted. After the notification is transmitted, the notification time instant is set to the fourth time instant of 16:35. Consequently, a record 1304 is created.

In response to the third notification, the user returns an acknowledgement to the notification program 102. At this time, the member ID code “0001” is recorded in the acknowledgement table 1100.

At the fourth notification time instant of 16:35, since the member ID code “0001” is recorded in the acknowledgement table 1100, the notification program 102 changes the call origination flag from 01 (meaning that notification is requested) to 00 (meaning that notification is not requested). Consequently, a record 1305 is created. Since the call origination flag is reset to 00, the user will not be notified at step S406 or a subsequent step. The notification program 102 merely monitors the current time instant to see if the current time instant has reached the arrival time instant 17:10. When the arrival time instant has come (or has elapsed), the record associated with the member ID code “0001” is deleted.

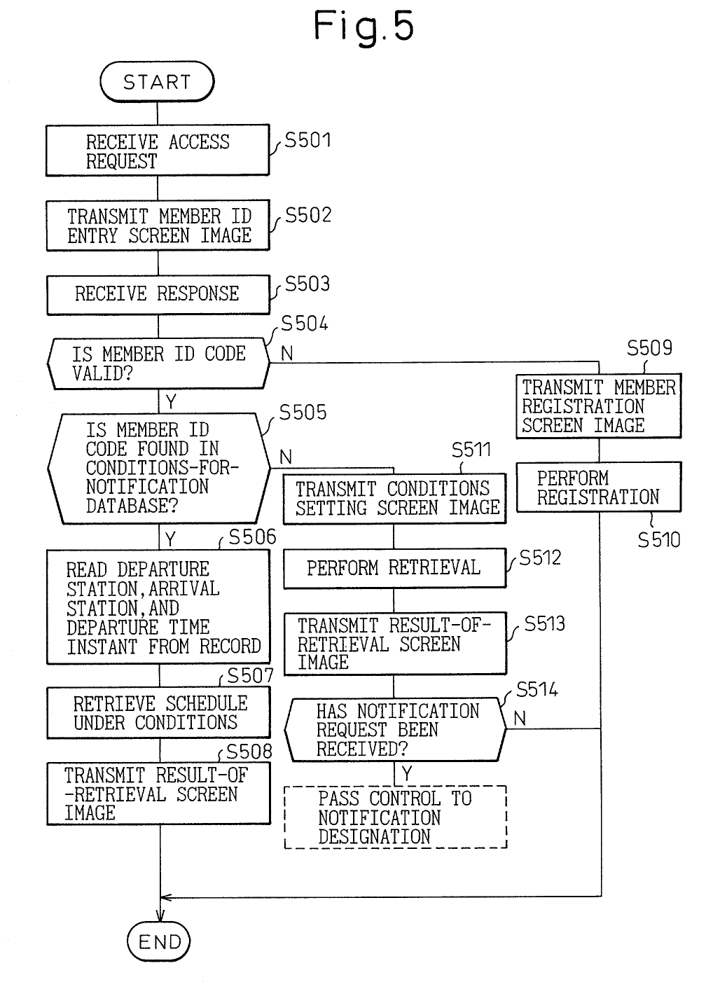

Finally, retrieval comparable to step S205 will be described in conjunction with the flowchart of FIG. 5.

At step S501, the retrieval program 101 receives a request to locate a web page (not shown), which is produced by the retrieval program 101, from the user terminal 130.

At step S502, the retrieval program 101 transmits a screen image, which prompts a user to enter his/her member ID code, to the user terminal 130. At step S503, the retrieval program 101 receives a response to the prompt from the user terminal 130. At step S504, it is judged whether the received response specifies a member ID code. If a member ID code is specified, it is judged whether the member ID code is recorded in the member table 1000.

If the member ID code is not recorded in the member table 1000 or if the member ID code is not specified in the response, the retrieval program 101 proceeds to step S509, and transmits a member registration screen image to the user terminal 130. At step S510, registration is performed and the processing sequence is completed. However, the processing sequence may be designed so that after the registration of step S510 is completed, step S511 and subsequent steps are carried out.

If it is judged at step S504 that the member ID code transmitted from the user terminal 130 is a valid member ID code recorded in the member table 1000, the retrieval program 101 judges at step S505 whether the record of the user having the member ID code is contained in the conditions-for-notification table 1200. In other words, at step S505, the retrieval program 101 judges whether the member has already retrieved a transport schedule or a plan to change trains and designated notification.

If it is judged at step S505 that the member ID code is found in the conditions-for-notification table, the retrieval program reads the departure station, arrival station, and departure time instant from the columns 1202, 1203, and 1204 of the record. At step S507, the timetable database 103 is searched under the conditions in order to retrieve a transport schedule. At step S508, a screen image presenting the result of retrieval is transmitted to the user terminal 130, and the retrieval is terminated. Owing to the foregoing processing, when a user who has designated notification merely enters his/her member ID code, a result-of-retrieval screen image presenting a transport schedule or plan to change trains based on which notification is designated is automatically displayed.

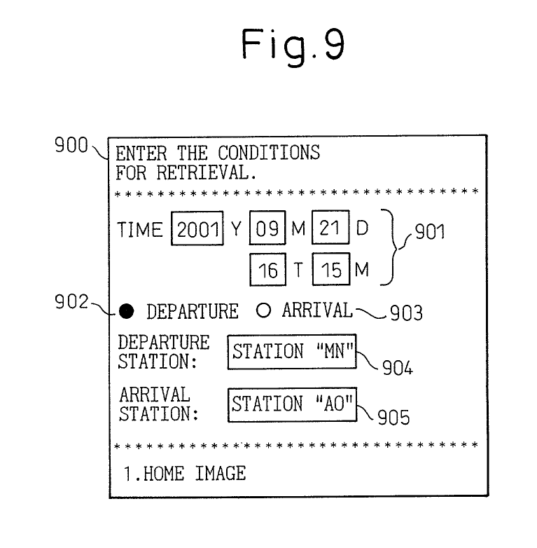

In contrast, if it is judged at step S505 that the record of the member ID code is not found in the conditions-for-notification table 1200, the retrieval program 101 recognizes that a user newly wants to retrieve a transport schedule or plan to change trains. At step S511, the retrieval program 101 transmits a screen image, which prompts a user to enter the conditions for retrieval, to the user terminal 130. The conditions-for-retrieval entry screen image is, for example, like the one shown in FIG. 9. The conditions-for-retrieval entry screen image 900 permits entry of a date 901, a departure station 904, and an arrival station 905. Moreover, the conditions-for-retrieval entry screen image 900 also presents a departure selection button 902 to be pressed when the date is equivalent to a departure time instant, and an arrival selection button 903 to be pressed when the date is equivalent to an arrival time instant.

At step S512, the retrieval program 101 searches the timetable database according to the data of the conditions for retrieval sent from the user terminal 130 so as to retrieve a transport schedule or plan to change trains. At step S513, a screen image presenting the result of retrieve is returned. The result-of-retrieve screen image is, for example, like the one shown in FIG. 6.

If a user accepts the result of retrieve 602 and designates notification, the user presses the automatic calling designation button 604. If the user does not want to designate notification, the user selects any other button, for example, the return-to-conditions setting screen image button 603 or the return-to-home screen image button 605.

At step S514, the retrieval program 101 judges whether the user has designated notification in relation to the result of retrieval. If the retrieval program 101 receives a notification request issued in response to the user's press of the automatic calling designation button 604, the retrieval program 101 proceeds with the notification designation sequence described in FIGS. 3A to 3B. If the notification program 101 does not receive the notification request, the notification program 101 complies with a response sent from the user terminal 130. The retrieval sequence is then terminated.

Hardware constituting the notification system 100 includes a CPU, a ROM, a RAM, a hard disk drive (HDD), a hard disk (HD), floppy disk drive (FDD), a floppy disk (FD) that is one kind of detachable recording media, a display, an interface (I/F), a keyboard, and a mouse. Moreover, the components are interconnected over a bus.

The CPU is responsible for control of the entire notification system 100. A bootstrap program and other programs are stored in the ROM. The RAM is used as a work area. The HDD controls reading or writing of data from or on the hard disk under the control of the CPU. Data written under the control of the HDD is stored on the hard disk.

The FDD controls reading or writing of data from or on a floppy disk under the control of the CPU. Data written under the control of the FDD is stored on the floppy disk, or data stored on the floppy disk is read into an information processing unit. Aside from the floppy disk, a CD-ROM (CD-R or CD-RW disk), a magneto-optical (MO) disk, a digital versatile disk (DVD), or a memory card may be included as a detachable recording medium. The display is realized with, for example, a CRT, a TFT liquid crystal display, or a plasma display on which a cursor, icons or a tool box, and windows (browser) for presenting a document, an image, functional information, and others are displayed.

When the CPU runs the retrieval program 101 or notification program 102 saved on the ROM, RAM, hard disk, or floppy disk, the features are realized.

Moreover, various data items and part of the data tables recorded in the databases 103 to 106 may be produced or deleted in or from the RAM, which is used as a work area, if necessary.

The interface (I/F) is connected onto a LAN, the Internet, or any other network by way of a communication line, and connected to other information processing units (server, etc.) over the network. The interface is responsible for the interface between the network and the notification system, and controls input or output of data from or to the other server or information terminal. The interface is realized with, for example, a modem. Moreover, when an information provision system communicates with a portable telephone by radio, the interface has the capability of a communication device (radio transmitter receiver).

The keyboard has keys that are used to enter characters, numerals, or various instructions, and is thus used to enter data. The keyboard may be provided as a touch-sensitive entry pad or the like. The mouse is used to move the cursor, define a range, move a window, change the size of a window, or the like. Alternatively, a trackball or a joystick will do as long as it has the capability of a pointing device.

According to the present invention, there is provided a notification method comprising the steps of: referencing a transport schedule registered at a user terminal and judging whether it is the time instant when a notification concerning the schedule should be transmitted; and if it is judged that it is the time instant when the notification should be transmitted, transmitting the notification to a contact address registered at the user terminal.

In the notification method, preferably, the transport schedule presents a moving time required for a user to reach a point of departure of an initially utilized transport. A time instant earlier than the departure time instant of the initially utilized transport by the moving time is calculated and regarded as a user departure time instant. Whether the notification should be transmitted is judged from the user departure time instant.

In the notification method, preferably, the transport schedule presents a time instant at which the notification is transmitted automatically. Whether the notification should be transmitted is judged from the transmission time instant.

In the notification method, preferably, the transport schedule presents a time instant at which the notification is retransmitted automatically. Whether the notification should be transmitted is judged from the retransmission time instant.

In the notification method, preferably, if it is judged that the transmission time instant or retransmission time instant is later than the user departure time instant, the user departure time instant is updated to the transmission time instant or retransmission time instant. Based on the updated user departure time instant, a transport schedule is retrieved from a timetable database in which timetables of transports are recorded. A transport schedule that is the result of retrieval is transmitted during the notification.

In the notification method, preferably, the transport schedule presents a member ID code registered in advance and an arrival time instant at a final point of arrival. In response to the member ID code, the transport schedule is transmitted to the user terminal, from which the member ID code is transmitted, until the arrival time instant.

In the notification method, preferably, the transport schedule presents information that specifies a transmission medium over which a notification is transmitted to the contact address. The notification is transmitted over the specified transmitting medium.

According to the present invention, there is provided a notification program for allowing a computer to act as: a judging means for referencing a transport schedule registered at a user terminal and judging whether a notification concerning the schedule should be transmitted; and a transmitting means for if it is judged that the notification should be transmitted, transmitting the notification to a contact address registered at the user terminal.

In the notification program, preferably, the transport schedule presents a moving time required for a user to reach a point of departure of an initially utilized transport. The judging means judges from a user departure time instant, which is earlier than the departure time instant of the initially utilized transport by the moving time, whether the notification should be transmitted.

In the notification program, preferably, the transport schedule presents a time instant at which a notification is transmitted automatically. Whether the notification should be transmitted is judged from the transmission time instant.

Preferably, the transport schedule presents a time instant at which a notification is retransmitted automatically. Whether the notification should be transmitted is judged from the retransmission time instant.

In the notification program, preferably, if it is judged that the transmission time instant or retransmission time instant is later than the user departure time instant, the user departure time instant is updated to the transmission time instant or retransmission time instant. Based on the updated user departure time instant, a transport schedule is retrieved from a timetable database in which timetables of transports are recorded. The transport schedule that is the result of retrieval is transmitted during the notification.

In the notification program, preferably, the transport schedule presents a member ID cord registered in advance and an arrival time instant at a final point of arrival. In response to the member ID cord, the schedule is transmitted to the user terminal, from which the member ID code is transmitted, until the arrival time instant.

In the notification program, preferably, the transport schedule presents information that specifies a transmission medium over which a notification is transmitted to the contact address. The notification is transmitted over the specified transmission medium.

According to the present invention, there is provided a notification system including a judging means and a transmitting means. The judging means references a transport schedule registered at a user terminal and judges whether a notification concerning the schedule should be transmitted. If it is judged that the notification should be transmitted, the transmitting means transmits the notification to a contact address registered at the user terminal.

In the notification system, preferably, the transport schedule presents a moving time required for a user to reach a point of departure of an initially utilized transport. The judging means judges from a user departure time, which is earlier than the departure time instant of the initially utilized transport by the moving time, whether the notification should be transmitted.

In the notification system, preferably, the transport schedule presents a member ID cord registered in advance and the arrival time instant at a final point of arrival. In response to the member ID cord, the schedule is transmitted to the user terminal, from which the member ID cord is transmitted, until the arrival time instant.

As described so far, a notification method, program, and system in accordance with the present invention can notify a user to leave so that the user can catch his/her scheduled transport.

Furthermore, the notification method, program, and system in accordance with the present invention permit a user to reuse the initial conditions for retrieval or a transport schedule that is the result of retrieval performed under the conditions for retrieval. Moreover, the notification method, program, and system can provide a new schedule if the user misses the initially scheduled transport.

What is claimed is:

1. A notification method comprising the steps of:
referencing a transport schedule registered at a user terminal and judging whether a notification concerning the schedule should be transmitted; and
if it is judged that the notification should be transmitted, transmitting the notification to a contact address registered at the user terminal.

2. A notification method according to claim 1, wherein: the transport schedule presents a moving time required for a user to reach a point of departure of an initially utilized transport; a time instant earlier than the departure time instant of the initially utilized transport by the moving time is calculated as a user departure time instant; and whether the notification should be transmitted is judged from the user departure time instant.

3. A notification method according to claim 1, wherein the transport schedule presents a time instant at which a notification is transmitted automatically, and whether the notification should be transmitted is judged from the transmission time instant.

4. A notification method according to claim 1, wherein the transport schedule presents a time instant at which a notification is retransmitted automatically, and whether the notification should be transmitted is judged from the retransmission time instant.

5. A notification method according to claim 4, wherein: if it is judged that the transmission time instant or retransmission time instant is later than the user departure time instant, the user departure time instant is updated to the transmission time instant or retransmission time instant; a transport schedule is retrieved from a timetable database, in which timetables of transports are recorded, according to the updated user departure time instant; and the transport schedule that is the result of retrieval is transmitted during the notification.

6. A notification method according to claim 1, wherein: the transport schedule presents a member ID code registered in advance and an arrival time instant at a final point of arrival; and in response to the member ID cord, the schedule is transmitted to the user terminal, from which the member ID code is transmitted, until the arrival time instant.

7. A notification method according to claim 1, wherein the transport schedule presents information that specifies a transmission medium over which a notification is transmitted to the contact address, and the notification is transmitted over the specified transmission medium.

8. A notification program allowing a computer to act as:
a judging means for referencing a transport schedule registered at a user terminal and judging whether a notification concerning the schedule should be transmitted; and
a transmitting means for, if it is judged that the notification should be transmitted, transmitting the notification to a contact address registered at the user terminal.

9. A notification program according to claim 8, wherein: the transport schedule presents a moving time required for a user to reach a point of departure of an initially utilized transport; and said judging means judges from a user departure time instant, which is earlier than the departure time instant of the initially utilized transport by the moving time, whether the notification should be transmitted.

10. A notification system comprising:
a judging means for referencing a transport schedule registered at a user terminal and judging whether a notification concerning the schedule should be transmitted; and
a transmitting means for, if it is judged that the notification should be transmitted, transmitting the notification to a contact address registered at the user terminal.
